(19) United States
(12) Patent Application Publication
(10) Pub. No.: US 2011/0093607 A1
(43) Pub. Date: Apr. 21, 2011

(54) METHOD, DEVICE, AND APPARATUS FOR PROVIDING MEDIA STREAM SERVICE

(75) Inventors: Zhibing WANG, Shenzhen (CN); Haijun Jiang, Shenzhen (CN)

(73) Assignee: HUAWEI TECHNOLOGIES CO., LTD., Shenzhen (CN)

(21) Appl. No.: 12/978,818

(22) Filed: Dec. 27, 2010

Related U.S. Application Data
(63) Continuation of application No. PCT/CN2009/071294, filed on Apr. 16, 2009.

(30) Foreign Application Priority Data
Jun. 27, 2008 (CN) 200810127546.8

(51) Int. Cl. G06F 15/16

(52) U.S. Cl. 709/231; 709/235

(57) ABSTRACT

A method and system for providing a media stream service are provided. The method includes: receiving a request of providing a media stream service sent by a user terminal, the request carrying information of a Service Provider (SP); obtaining an ability strategy of the SP according to the SP's information carried in the request; and selecting, according to the ability strategy of the SP, a Content Delivery Network (CDN) or Peer to Peer (P2P) mode to provide the media stream service for the user. Through the technical solutions, the CDN or P2P mode can be selected, according to the ability strategy of the SP or current ability operating statuses of the CDN and the P2P, to provide the media stream service for the user.

### CROSS-REFERENCE TO RELATED APPLICATIONS

This application is a continuation of International Application No. PCT/CN2009/071294, filed on Apr. 16, 2009, which claims priority to Chinese Patent Application No. CN 200810127546.8, filed on Jun. 27, 2008, both of which are hereby incorporated by reference in their entireties.

### FIELD OF THE INVENTION

The present invention relates to the field of Internet communications technologies, and in particular to a method, a system, and an apparatus for providing a media stream service.

### BACKGROUND OF THE INVENTION

Currently, the main modes for providing media stream services include a centralized mode, a distributive mode, and a Peer to Peer (P2P) mode. The centralized mode refers to that media stream servers are centralized in a data center or a Service Provider/Content Provider (SP/CP) website to provide services for a user directly. The SP/CP needs to establish a media stream operating system independently to support operation of the media stream services. The distributive mode refers to the uniform management, maintenance, and operation by using a Content Delivery Network (CDN) hierarchical networking mode and management components, and an edge server is responsible for providing content for the user nearby, so as to ensure the quality of service of the content. The P2P mode refers to installing a P2P client on a computer of an end user, and content services may be performed between the clients. In this mechanism, by making use of storage and uplink bandwidth resources of a user side, the resources at a server side may be saved.

Operation modes of the CDN currently include a self-managing mode and a resource-rent mode. In the self-managing mode, the CP provides the content, and the operator runs services through a self-established service system. In the resource-rent mode, as a service acceleration network, the CDN needs to interconnect upwardly with each SP service system, so as to enhance the service ability of the SP system. At present, the media steam service mode mostly adopted by the operators is to deploy conventional CDN networks, and in large networks, the CDN is adopted to support the self-managing and the resource-rent services at the same time. In the conventional CDN networking, user access scheduling generally includes global scheduling and local scheduling. A Global Server Load Balance (GSLB) is deployed in central nodes, and local scheduling components are deployed at a center, backbones, and edges. A typical disadvantage of this solution is of high investment costs. The user experience is good due to the distributive networking. However, the C/S mode is adopted between the user and the server, and the server is required to provide all service abilities. Especially, when the resource-rent mode appears, the demand for network resources increases greatly, and with the development of the service, the solution requires the operator to invest a large sum of money to continuously expand the capacity of the network.

The P2P solution currently suitable for operators to develop large-scale services is to set up a P2P network based on CDN hierarchical architecture, and the network controls P2P traffic through an autonomous domain. Compared with the pure CDN network, the P2P technology makes full use of resources at the user side, and lowers the ability requirements for the server to a certain degree, thus reducing the investment costs of the operators. In this P2P service solution, the user access scheduling may be classified into global scheduling and local scheduling, the GSLB is deployed on the central nodes, and an SLB is implemented through a P2P service resource manager, and the service resource manager may be deployed on the central nodes and edge nodes, respectively. The P2P media stream service solution still has obvious disadvantages. Usually, a process of initiating the P2P ability through a script should be added on a portal website and the user side is forced to install the client, which affects the user experience to a certain extent and causes the leaving of some users.

During the implementation of the present invention, the inventor finds that the conventional art has at least the following problems. In the prior art, the CDN or P2P media stream mode can only be adopted solely, which is not flexible enough and inapplicable to variety demands of users.

### SUMMARY OF THE INVENTION

The present invention is directed to a method and a system for providing a media stream service, where the CDN or P2P mode can be selectively adopted to provide the media stream service for the user, so as to reduce the network costs and enhance the user experience.

In order to solve the technical problems above, the objectives of the present invention are implemented through the following technical solutions.

A method for providing a media stream service is provided, where the method includes:
receiving a request of providing a media stream service sent by a user terminal, where the request carries information of an SP;
obtaining an ability strategy of the SP according to the SP's information carried in the request, where the ability strategy includes a CDN ability and/or P2P ability; and
selecting, according to the ability strategy of the SP, a CDN or P2P mode to provide the media stream service for a user.

A method for providing a media stream service is provided, where the method includes:
receiving a request of providing a media stream service sent by a user terminal; and
selecting, according to current ability operating statuses of a CDN and a P2P, a CDN mode or P2P mode to provide the media stream service for a user.

A system for providing a media stream service is provided, where the system includes:
an SLB, configured to obtain an ability strategy of an SP according to the SP's information carried in a received request of providing a media stream service, and select, according to the ability strategy of the SP, a CDN or P2P mode to provide the media stream service for the user.

An SLB is provided, where the SLB includes:
a receiving unit, configured to receive a request of providing a media stream service sent by a user terminal, where the request carries information of an SP;
an information acquisition unit, configured to acquire, according to the SP's information carried in the request received by the receiving unit, an ability strategy of the SP configured by an operating system; and
a selecting unit, configured to select a CDN or P2P mode to provide the media stream service for a user according the SP's ability strategy obtained by the information acquisition unit.

A system for providing a media stream service is provided, where the system includes:
an SLB, configured to select, according to a received request of a media stream service and current ability operating statuses of a CDN and a P2P, a CDN or P2P mode to provide the media stream service for a user.

An SLB is provided, where the SLB includes:
a receiving unit, configured to receive a request of a media stream service sent by a user terminal;
an ability acquisition unit, configured to obtain current ability operating statuses of a CDN and a P2P; and
a selecting unit, configured to select, according to the request of the media stream service received by the receiving unit and current ability operating statuses of the CDN and the P2P obtained by the ability acquisition unit, a CDN or P2P mode to provide the media stream service for a user.

Persons of ordinary skill in the art should understand that all or a part of the steps of the method according to the embodiments of the present invention may be implemented by a program instructing relevant hardware. The program may be stored in a computer readable storage medium, such as a Read Only Memory (ROM), a Random Access Memory (RAM), a magnetic disk, and an optical disk.

In the embodiments of the present invention, the CDN or P2P mode is selected, according to the ability strategy of the SP or current ability operating statuses of the CDN and the P2P, to provide the media stream service for the user, so that the user can select the service mode flexibly and get better service experience.

### BRIEF DESCRIPTION OF THE DRAWINGS

FIG. 1 is a flow chart of a method for providing a media stream service according to an embodiment of the present invention;

FIG. 2 is a flow chart of a method for providing a media stream service according to another embodiment of the present invention; and

FIG. 3 is a schematic structural view of a system for providing a media stream service according to an embodiment of the present invention.

### DETAILED DESCRIPTION OF THE EMBODIMENTS

In an embodiment, the present invention provides a method and a system for providing a media stream service. In order to make the technical solution according to the present invention clearer and more comprehensible, the present invention is further described in the following with reference to the accompanying drawings and embodiments.

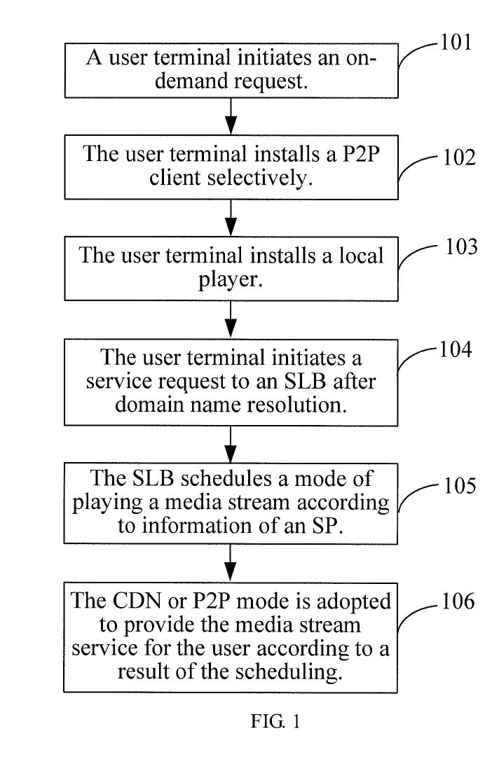

FIG. 1 is a flow chart of a method for providing a media stream service according to an embodiment of the present invention.

Referring to FIG. 1, before the media stream service is provided for the user: First, an operating system configures an ability strategy of an SP and allocates available resources of CDN for the SP; next, the SP distributes contents, shows a media stream service provided by the SP on an SP portal website, and provides the media stream service for the user through the SP portal website. In the embodiment of the present invention, the ability strategy of the SP includes strategy 1, strategy 2, and strategy 3.

In strategy 1, the SP uses a conventional CDN ability in the system, and an operator allocates conventional ability resources for the SP (including the number of the concurrent users and bandwidth resources).

In strategy 2, the SP uses a P2P ability, and the operator allocates P2P resources for the SP (including the number of the concurrent users and bandwidth resources). At this case, a script provided by the system is briefly introduced into the SP portal website for accomplishing functions such as the installation and initiation of a P2P client.

In strategy 3, the SP uses the CDN ability and P2P ability, and the operator allocates general resources for the SP (including the number of the concurrent users and bandwidth resources). At this case, a P2P script is introduced into the SP portal website. However, during the operation, the specific ability to be adopted to provide the service is determined by an SLB according to the practical ability of the system. The SLB obtains and records ability operating statuses of the CDN and the P2P in real time when providing the media stream service, which includes the following: The SLB regularly obtains the ability operating status of the CDN from a medium stream server; the SLB regularly obtains the ability operating status of the P2P from a P2P service resource manager.

In addition, after configuring the ability strategy of the SP and allocating the CDN available resources for the SP, the operating system notifies SLB of the ability strategy configured on each SP.

A specific process of providing the media stream service includes the following steps.

In step 101, a user terminal logs in to the SP portal, and initiates an on-demand request.

In step 102, the user terminal installs a P2P client selectively.

An Internet Explorer (IE) tries to pull the P2P client through a script, and the user selects whether to install the P2P client.

If the P2P client has been installed at the user side, step 102 may be omitted.

In step 103, the user terminal installs a local player.

In step 104, the user terminal performs Domain Name Server (DNS) resolution according to a domain name in the on-demand request of the user to obtain a corresponding Internet Protocol (IP) address. A media stream player initiates, to the SLB and according to the IP address obtained from resolution, a request of providing the media stream service, where the service request carries a Uniform Resource Locator (URL) of the on-demand content of the user.

The URL includes information of the SP to which the on-demand content of the user belongs. The URL may also carry an installation result of the P2P client on the user terminal.

In step 105, the SLB schedules, according to the obtained information of the SP, a mode for playing a media stream, that is, selects a specific mode to provide the media stream service for the user.

Specifically, step 105 specifically includes the following steps.

The SLB determines, according to the information, such as a domain name, of the SP in the URL, the SP to which the on-demand content of the user belongs.

The SLB searches the ability strategy configured on the SP, and selects, according to the ability strategy of the SP, the CDN or P2P mode to provide the media stream service for the user.

After configuring the ability strategy of the SP and allocating the CDN available resources for the SP, the operating system notifies the SLB of the ability strategy configured in each SP, so the SLB can find the ability strategy of the SP according to the SP.

If the SP adopts strategy 1 above, the CDN mode is selected to provide the media stream service for the user on the premise that idle resources still exit in the SP. If the SP adopts strategy 2, and the user installs the P2P client, the P2P mode is selected to provide the media stream service for the user on the premise that idle resources still exist in the SP. If the SP adopts strategy 3, the mode that has more remaining resources and is in normal service is selected, according to current ability operating statuses of the CDN and the P2P, to provide the media stream service for the user. Thus, consumption of the two abilities is balanced in the system, so as to utilize system resources to the greatest extent. As described above, current ability operating statuses of the P2P and the CDN may be obtained by the SLB in real time when the media stream service is being provided.

For example, when the SP adopts strategy 3, that is, both the CDN and P2P abilities may be used by the SP, and first it is judged whether the P2P client is installed on the user terminal. If the P2P client is installed on the user terminal, the mode that has more remaining resources and is in normal service is selected, according to current ability statuses of the P2P and the conventional CDN, to provide the service for the user. If the P2P client is not installed on the user terminal, the CDN mode is directly selected to provide the media stream service for the user.

In Step 106, the SLB redirects the player on the user terminal to a corresponding target device such as the P2P client or a media server (MS) according to a scheduling result, and the target device uses the P2P or CDN mode to provide the media stream service for the user.

When the SLB selects to use the CND mode to provide the media stream service for the user, Step 106 further includes the following steps.

1. The player initiates a service request to the MS with a conventional CDN ability.

2. The MS provides the media stream for the player after the authentication is successful.

When the SLB selects to use the P2P mode to provide the media stream service for the user, Step 106 further includes the following steps.

1. The player initiates a service request to a local P2P client.

2. The local P2P client requests P2P service resources from a service resource manager device.

3. The service resource manager returns a resource list.

4. The local P2P client obtains a part or all of the content data from the MS, or the local P2P client obtains other different service contents from other P2P clients respectively.

5. The local P2P clients integrate the obtained contents, and provide the media stream for the player.

In the embodiments of the present invention, the CDN or P2P mode is selected, according to the ability strategy of the SP or current ability operating statuses of the CDN and the P2P, to provide the media stream service for the user, so that the user can select the service mode flexibly and get better service experience.

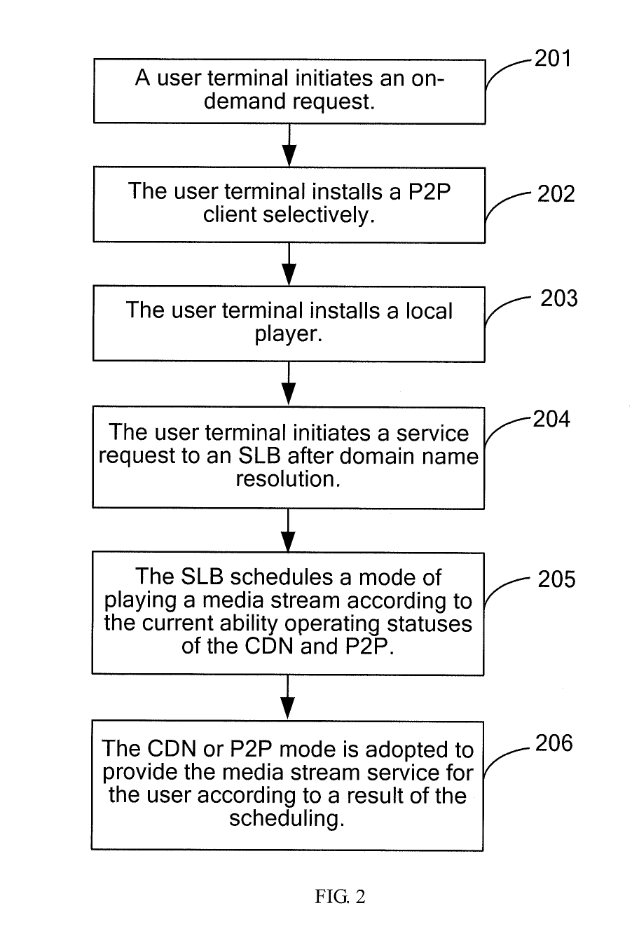

FIG. 2 is a flow chart of a method for providing a media stream service according to another embodiment of the present invention. In this embodiment, the SP may use the CDN ability and P2P ability simultaneously.

A specific process of providing the media stream service includes the following steps.

In Step 201, a user terminal logs in to the SP portal, and initiates an on-demand request.

In Step 202, the user terminal installs a P2P client selectively.

An IE tries to pull the P2P client through a script, and the user selects whether to install the P2P client.

If the P2P client is already installed at the user side, Step 102 may be omitted.

In Step 203, the user terminal installs a local player.

In Step 204, the user terminal performs DNS resolution according to a domain name in the on-demand request of the user to obtain a corresponding IP address, the media stream player initiates a service request to the SLB according to the IP address obtained from resolution, where the service request carries a URL of the on-demand content of the user.

The URL includes information of the SP to which the on-demand content of the user belongs. The URL may also carry an installation result of the P2P client on the user terminal.

In Step 205, a server load balance (SLB) schedules a mode of playing a media stream, that is, selects, according to current ability operating statuses of the CDN and the P2P, the mode to provide the media stream service for the user.

The SLB selects, according to current ability operating statuses of the P2P and the CDN, the mode that has more remaining resources and is in normal service between the CDN mode and the P2P mode to provide the media stream service for the user, so as to balance consumption of the two abilities in the system and make use of the system resources to the greatest extent.

Current ability operating statuses of the P2P and the CDN may be obtained in real time when the SLB provides the media stream service. For example, the SLB obtains the ability operating status of the CDN from an MS regularly, and the SLB obtains the ability operating status of the P2P through a P2P service resource manager regularly.

In addition, the SLB may also combine the installation result of the P2P client on the user terminal and the ability strategy of the SP to select the CDN or P2P mode to provide the media stream service for the user.

For example, when strategy 3 is adopted by the SP, that is, both the abilities of CDN and P2P may be used by the SP, first it is judged whether a P2P client is installed on a user terminal. If the P2P client is installed on the user terminal, the mode that has more remaining resources and is in normal service is selected, according to the current ability condition of the P2P and the conventional CDN, to provide the service for the user. If the P2P client is not installed on the user terminal, the CDN mode is directly selected to provide the media stream service for the user.

In step 206, the SLB redirects the player on the user terminal to a corresponding target device, for example, the P2P client or the MS, according to a scheduling result, and the target device uses the P2P or CDN mode to provide the media stream service for the user.

When the SLB selects to use the CND mode to provide the media stream service for the user, step 206 further includes the following steps.

1. The player initiates a service request to an MS with a conventional CDN ability.

2. The MS provides the media stream for the player after the authentication is successful.

When the SLB selects to use the P2P mode to provide the media stream service for the user, step 206 further includes the following steps.

1. The player initiates a service request to a local P2P client.

2. The local P2P clients requests P2P service resources from a service resource manager device.

3. The service resource manager returns a resource list.

4. The local P2P client obtains a part or all of the content data from the MS, or the local P2P client obtains other different service contents from other P2P clients respectively.

5. The local P2P clients integrate the obtained contents, and provide the media stream for the player.

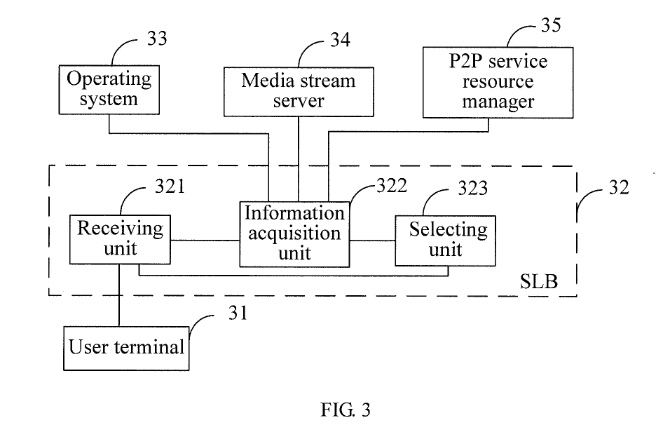

FIG. 3 is a schematic structural view of a system for providing a media stream service according to an embodiment of the present invention.

Referring to FIG. 3, the system for providing a media stream service includes a user terminal 31, an SLB 32, an operating system 33, a media stream server 34, and a P2P service resource manager 35.

The user terminal 31 is configured to send a request of providing a media stream service to the SLB 32, where the request carries information of an SP.

The SLB 32 is configured to obtain an ability strategy of the SP according to the SP's information carried in the request, and selects, according to the ability strategy of the SP, a CDN or P2P mode to provide the media stream service for the user.

If the ability strategy of the SP is using a conventional CDN ability, the SLB 32 selects the CDN mode to provide the media stream service for the user. If the ability strategy of the SP is using a P2P ability, the SLB 32 selects the P2P mode to provide the media stream service for the user. If the ability strategy of the SP is using the CDN ability and P2P ability, the SLB 32 selects, according to current ability operating statuses of the P2P and the CDN, the mode that has more remaining resources and is in normal service between the CDN mode and the P2P mode to provide the media stream service for the user.

The operating system 33 is configured to configure the ability strategy of the SP, and notify the SLB 32 of the ability strategy of the SP.

The media stream server 34 is adapted to provide the ability operating status of the CDN for the SLB 32. The P2P service resource manager 35 is adapted to provide the ability operating status of the P2P for the SLB 32. If the ability strategy of the SP is using the CDN ability and the P2P ability, the SLB 32 selects, according to current ability operating statuses of the P2P and the CDN, the mode that has more remaining resources and is in normal service between the CDN mode and the P2P mode to provide the media stream service for the user.

The SLB 32 may further include a receiving unit 321, an information acquisition unit 322, and a selecting unit 323.

The receiving unit 321 is configured to receive a request of providing the media stream service sent by a user terminal, where the request carries the SP's information.

The information acquisition unit 322 is configured to obtain, according to the SP's information carried in the request received by the receiving unit 321, the ability strategy of the SP configured by the operating system.

The selecting unit 323 is configured to select, according to the ability strategy of the SP obtained by the information acquisition unit 322, the CDN or P2P mode to provide the media stream service for a user.

If the ability strategy of the SP is using the conventional CDN ability, the selecting unit 323 selects the CDN mode to provide the media stream service for the user.

If the ability strategy of the SP is using the P2P ability, the selecting unit 323 selects the P2P mode to provide the media stream service for the user.

If the ability strategy of the SP is using the CDN ability and P2P ability, the selecting unit 323 selects, according to current ability operating statuses of the P2P and the CDN, the mode that has more remaining resources and is in normal service between the CDN mode and the P2P mode to provide the media stream service for the user.

The SLB 32 may further include an ability acquisition unit.

The ability acquisition unit is configured to obtain ability operating statuses of the CDN and the P2P in the network, and notify the selecting unit. If the ability strategy of the SP is using the CDN ability and P2P ability, the mode that has more remaining resources and is in normal service is selected, according to current ability operating statuses of the P2P and the CDN obtained by the ability acquisition unit, to provide the media stream service for the user.

The present invention further provides a system for providing a media stream service in another embodiment, where the system includes a user terminal and an SLB.

The user terminal is configured to send a request of providing a media stream service.

The SLB is configured to select, according to the request of providing the media stream service and current ability operating statuses of the CDN and the P2P, a CDN or P2P mode to provide the media stream service for a user.

The system for providing a media stream service may further include a media stream server and a P2P service resource manager.

The media stream server is configured to provide the ability operating status of the CDN for the SLB.

The P2P service resource manager is configured to provide the ability operating status of the P2P for the SLB.

The SLB selects, according to ability operating statuses of the P2P and the CDN, the mode that has more remaining resources and is in normal service between the CDN mode and the P2P mode to provide the media stream service for the user.

The SLB may further include a receiving unit, an ability acquisition unit, and a selecting unit.

The receiving unit is configured to receive a request of a media stream service sent by a user terminal.

The ability acquisition unit is configured to obtain current ability operating statuses of the CDN and the P2P.

The selecting unit is configured to select, according to the request of the media stream service received by the receiving unit and current ability operating statuses of the CDN and the P2P obtained by the ability acquisition unit, the CDN or P2P mode to provide the media stream service for the user.

Through the method and system for providing the media stream service according to the embodiments of the present invention, the CDN or P2P mode can be selected, according to the ability strategy of the SP or current ability operating statuses of the CDN and the P2P, to provide the media stream service for the user.

Persons of ordinary skill in the art should understand that all or a part of the steps of the method according to the embodiments of the present invention may be implemented by a program instructing relevant hardware. The program may be stored in a computer readable storage medium, such as a Read Only Memory (ROM), a Random Access Memory (RAM), a magnetic disk, and an optical disk.

The method and system for providing a media stream service of the present invention are described in detail above. The principle and implementation mode of the present invention are described herein through specific examples. The description about the embodiments of the present invention is merely provided for ease of understanding of technical solutions of the present invention. Persons of ordinary skill in the art can make changes to the present invention in terms of the specific implementations and application scopes according to the ideas of the present invention. Therefore, the contents of the specification shall not be construed as limiting the present invention.

What is claimed is:

1. A method for providing a media stream service, comprising:
receiving a request of providing a media stream service sent by a user terminal, wherein the request carries information of a Service Provider (SP);
obtaining an ability strategy of the SP according to the SP's information carried in the request; and
selecting, according to the ability strategy of the SP, a Content Delivery Network (CDN) mode or a Peer to Peer (P2P) mode to provide the media stream service for a user.

2. The method for providing a media stream service according to claim 1, further comprising:
receiving a notice concerning the ability strategy of the SP sent by an operating system.

3. The method for providing a media stream service according to claim 1, wherein the selecting, according to the ability strategy of the SP, the CDN mode or P2P mode to provide the media stream service for the user comprises:
if the ability strategy of the SP is using a CDN ability, selecting the CDN mode to provide the media stream service for the user;
if the ability strategy of the SP is using a P2P ability, selecting the P2P mode to provide the media stream service for the user; and
if the ability strategy of the SP is using the CDN ability and P2P ability, selecting, according to current ability operating statuses of a P2P and a CDN, the mode that has more remaining resources and is in normal service between the CDN mode and the P2P mode to provide the media stream service for the user.

4. The method for providing a media stream service according to claim 1, further comprising: obtaining ability operating statuses of the CDN and the P2P in a network,
wherein the selecting, according to the ability strategy of the SP, the CDN or P2P mode to provide the media stream service for the user comprises:
if the ability strategy of the SP is using a CDN ability and P2P ability, selecting, according to current ability operating statuses of the P2P and the CDN, the mode that has more remaining resources and is in normal service between the CDN mode and the P2P mode to provide the media stream service for the user.

5. The method for providing a media stream service according to claim 4, wherein the obtaining ability operating statuses of the CDN and the P2P in the network comprises:
obtaining the ability operating status of the CDN from a media stream server, and obtaining the ability operating status of the P2P from a P2P service resource manager.

6. A method for providing a media stream service, comprising:
receiving a request of providing a media stream service sent by a user terminal; and
selecting, according to current ability operating statuses of a Content Delivery Network (CDN) and a Peer to Peer (P2P), a CDN mode or P2P mode to provide the media stream service for the user.

7. The method for providing a media stream service according to claim 6, wherein the selecting, according to current ability operating statuses of the CDN and the P2P, the CDN mode or P2P mode to provide the media stream service for the user comprises:
selecting, according to current ability operating statuses of the CDN and the P2P, the mode that has more remaining resources and is in normal service between the CDN mode and the P2P mode to provide the media stream service for the user.

8. The method for providing a media stream service according to claim 7, further comprising:
regularly obtaining the ability operating status of the CDN from a media stream server, and regularly obtaining the ability operating status of the P2P from a P2P service resource manager.

9. A system for providing a media stream service, comprising:
a Server Load Balance (SLB), configured to obtain an ability strategy of a Service Provider (SP) according to information of the SP carried in a received request of providing a media stream service, and select, according to the ability strategy of the SP, a Content Delivery Network (CDN) mode or Peer to Peer (P2P) mode to provide the media stream service for a user.

10. The system for providing a media stream service according to claim 9, further comprising:
an operating system, configured to configure the ability strategy of the SP and notify the SLB of the ability strategy of the SP.

11. The system for providing a media stream service according to claim 9, wherein
if the ability strategy of the SP is using a CDN ability, the SLB selects the CDN mode to provide the media stream service for the user,
if the ability strategy of the SP is using a P2P ability, the SLB selects the P2P mode to provide the media stream service for the user, and
if the ability strategy of the SP is using the CDN ability and P2P ability, the SLB selects, according to current ability operating statuses of the P2P and the CDN, the mode that has more remaining resources and is in normal service between the CDN mode and the P2P mode to provide the media stream service for the user.

12. The system for providing a media stream service according to claim 9, further comprising:
a media stream server, adapted to provide an ability operating status of the CDN for the SLB; and
a P2P service resource manager, adapted to provide an ability operating status of the P2P for the SLB; wherein
if the ability strategy of the SP is using a CDN ability and P2P ability simultaneously, the SLB selects, according to current ability operating statuses of the P2P and the CDN, the mode that has more remaining resources and is in normal service between the CDN mode and the P2P mode to provide the media stream service for the user.

13. A Server Load Balance (SLB), comprising:
a receiving unit, configured to receive a request of providing a media stream service sent by a user terminal, wherein the request carries information of a Service Provider (SP);
an information acquisition unit, configured to obtain, according to the SP's information carried in the request received by the receiving unit, an ability strategy of the SP configured by an operating system; and
a selecting unit, configured to select, according to the ability strategy of the SP obtained by the information acquisition unit, a Content Delivery Network (CDN) mode or Peer to Peer (P2P) mode to provide the media stream service for a user.

14. The SLB according to claim 13, wherein
if the ability strategy of the SP is using a CDN ability, the selecting unit selects the CDN mode to provide the media stream service for the user,
if the ability strategy of the SP is using a P2P ability, the selecting unit selects the P2P mode to provide the media stream service for the user, and
if the ability strategy of the SP is using the CDN ability and P2P ability, the selecting unit selects, according to current ability operating statuses of the P2P and the CDN, the mode that has more remaining resources and is in normal service between the CDN mode and the P2P mode to provide the media stream service for the user.

15. The SLB according to claim 13, further comprising:
an ability acquisition unit, configured to obtain ability operating statuses of the CDN and the P2P in a network, and notify the selecting unit of ability operating statuses of the CDN and the P2P, wherein if the ability strategy of the SP is using a CDN ability and P2P ability, the mode that has more remaining resources and is in normal service is selected between the CDN mode and the P2P mode, according to current ability operating statuses of the P2P and the CDN obtained by the ability acquisition unit, to provide the media stream service for the user.

16. A system for providing a media stream service, comprising:
a Server Load Balance (SLB), configured to select, according to a received request of providing the media stream service and current ability operating statuses of the CDN and the P2P, a Content Delivery Network (CDN) or Peer to Peer (P2P) mode to provide the media stream service for a user.

17. The system for providing a media stream service according to claim 16, further comprising:
a media stream server, configured to provide the ability operating status of the CDN for the SLB,
a P2P service resource manager, configured to provide the ability operating status of the P2P for the SLB, wherein
the SLB selects, according to ability operating statuses of the P2P and the CDN, the mode that has more remaining resources and is in normal service between the CDN mode and the P2P mode to provide the media stream service for the user.

18. A Server Load Balance (SLB), comprising:
a receiving unit, configured to receive a request of a media stream service sent by a user terminal;
an ability acquisition unit, configured to obtain current ability operating statuses of a Content Delivery Network (CDN) and Peer to Peer (P2P); and
a selecting unit, configured to select, according to the request of the media stream service received by the receiving unit and current ability operating statuses of the CDN and the P2P obtained by the ability acquisition unit, a CDN mode or P2P mode to provide the media stream service for the user.
